(19) United States
(12) Patent Application Publication
(10) Pub. No.: US 2017/0369786 A1
(43) Pub. Date: Dec. 28, 2017

(54) MACROSCOPIC ARTIFICIAL DIELECTRIC SUSCEPTOR FOR MAKING BIOCHEMICALS

(71) Applicant: Robert Carl Dalton, Little Egg Harbor Township, NJ (US)

(72) Inventor: Robert Carl Dalton, Little Egg Harbor Township, NJ (US)

(21) Appl. No.: 15/193,052

(22) Filed: Jun. 25, 2016

(51) Int. Cl. C10B 19/00; C10B 53/02; C10G 2/00; C10G 15/08; C10G 47/00; C10G 45/02; C10G 32/02; C10G 3/00; B01J 19/12

(52) U.S. Cl. CPC C10B 19/00; C10G 3/42; C10B 53/02; C10G 2/00; B01J 19/122; C10G 47/00; C10G 45/02; C10G 32/02; C10G 15/08; C10G 3/50; B01J 2219/1203; B01J 2219/0879; B01J 2219/0892; C10G 2300/1011

(57) ABSTRACT

A macroscopic artificial dielectric susceptor for making biochemicals

### BACKGROUND OF THE INVENTION

### 1. Field of Invention

This invention relates to the use of macroscopic artificial dielectric (MAD) susceptor system with applied electromagnetic energy to produce biochemicals from biomass and biomass-derived molecules.

### 2. Background

Much current attention, as well as attention in the past decades, has been focused on renewable energy and chemicals that come from biomass. Biomass can produce many different products for energy and chemicals. For example, in the simplest case, wood from trees can be cut and resized to be burned “as is” in such products as wood pellets or “firewood”.

More complex methods and process are used to create biochemicals from bio-based feedstocks.

Biochemicals have several sources of bio-based feedstocks which can be categorized as a) solid biomass (solid plant matter) b) OFPA's (oils and free fatty acids of plants and animals), c) alcohols, d) sugars e) biogas, f) algae and e) other.

To generate OFPA's, plant seeds are usually crush to extract plant oils and fats. Also, chemicals can be used to extract the oils and fats. OFPA's from animals are usually extracted fats from butchered animals or greases from cooked meets with fats that are collect. Other sources can be used to obtain OFPA's.

The production of biochemicals from OFPA's generally use methods of transesterification, esterification, thermocracking, hydrocracking, and hydrotreatment of OFPA's. OFPA's can make Biodiesel (fatty acid methyl esters, ethyl esters and the like) renewable fuels (heating oil, biogasoline, biokerosene renewable diesel, renewable aviation fuel and etc.), and waxes. Other biochemicals include glycerin and engine coolants. Unlike biodiesels, other biochemicals including waxes and other renewable fuel employ more complex methods to produce commercially acceptable products.

hydrolysis synthesis is another process for producing biochemicals using sugars. Hydrolysis synthesis can extract sugars from cellulosic material. After the sugars are extracted, biochemicals can be formed with aqueous phase reforming (APR) methods with specific catalysts. The aqueous phase reforming can be used with deoxygenation-reforming catalysts also. These techniques can be used to form many products from oxygenates hydrocarbons. Furthermore, hydrodeoxygenation-catalytic reforming can be used.

Most of the sugars in the cellulose and hemicellulose are surrounded by lignin. Often, hydrolysis synthesis is proceeded by other processes that assist in extracting sugars by breaking down the surrounding lignin structure. (A method to breakdown the lignin structure can be used prior to pyrolysis, too).

Sugars include C5 sugars (xylose, arabinose, etc) C6 Sugars (mannose, glucose, fructose, galactose, etc), multiple oligo-saccharides, monosaccharides, disaccharides, trisaccharides and etc.

Thermal pyrolysis (or pyrolysis or depolymerization) is another process to produce biochemicals from solid biomass. Pyrolysis is generally used with solid biomass and less often used with liquids biomass. Pyrolysis produces solids, liquids and gases including water, char, carbons, oxygenates and liquids with acidic properties. Pyrolysis methods can use catalysts, and this method is called catalytic pyrolysis. Pyrolysis tends to have several temperature ranges were different products are produced. Thermal pyrolysis creates pyrolysis oil (bio-oil). The composition of pyrolysis oil is not constant. Different processes produce different pyrolysis oils, gas and solids. Reaction rates are important. Slow reaction rates and certain process conditions favor more solids being produced as products. Pyrolysis oils have high water contents and oxygen contents because oxygenates are produced during pyrolysis. Furthermore, pyrolysis oils have unstable chemicals in the oil.

The oxygenates of pyrolysis oil usually have to be refined by removing oxygen, and the water in the pyrolysis oil typically has to be reduced. Furthermore, processes have to be employed to improve the properties of the final product and to produce the desired chemicals for biofuels and biochemicals.

The chemical structure of the feedstock of biomass, pyrolysis oils, OFPA's, sugars differ greatly and the feedstocks themselves and products from the feedstocks are structurally different. For example, OFPA's typically have straight longer chain molecules that are used as reactants, where a greater quantity of cyclic compounds are found in pyrolysis oils when produce initially just using lignocellulose biomass as the initial feedstock. Subsequently, the pyrolysis oil can be used as a feedstock to produce other biochemicals by various processes producing a refined product or new chemicals species for a desired commercial use.

Often feedstocks, both primary and secondary feeds stocks need separation techniques and pretreatment processes to break cell walls so that chemical species are more readily available for other processes, remove solids, remove water, sulfur, metals and other chemical species. Several techniques are available to accomplish these tasks including distillation techniques, absorption techniques, demetallization techniques, hydrotreatment techniques include desulfurization, demetallization cracking and others, and other techniques.

Co-process of different biomass feedstocks, biochemicals, petroleum products and recycled polymers is possible (Brandvold et. All: U.S. Pat. No. 8,471,079).

Moreover, biochemicals can be used as drop-in fuels can be used, as drop-chemical substitutes, can be used as drop-in feedstock at petroleum refineries, and can be used substitute chemicals for other products and processes.

Production of biochemicals is a process or group of processes that depends on process economics and occasionally on process steps to create new products from feedstock. Feedstock economics is greatly important, too. These new products can become reactants for other products in serial reactions creating new products from new reactants until the desired final product or products is created.

Less expensive methods to produce biochemicals is of great value. Production of high value biochemicals such a BTX (benzene-toluene-xylene) are sought because there value is typically twice the value of biofuels.

In theory and practice, the thermodynamics and kinetics of using applied electromagnetic energy techniques for chemical processes differ from conventional techniques for chemical processes. Alternative methods using applied electromagnetic energy are more efficient methods, are less costly methods, are methods having lower capital costs. Such techniques are more flexible to create biochemicals in a chemical species flow of reactants with a structured macroscopic artificial dielectric susceptor in a macroscopic artificial dielectric systems using inert materials, heat carriers, catalysts and field concentrators.

Chemical reactors using applied electromagnetic energy techniques are more complex than conventional process. For example, the dielectric properties of the biomass solids, biomass liquids and biomass gas are different, and these types of biomass react differently with applied electromagnetic energy. The dielectric properties of the solids, liquids and gas change with temperature as well as with phase changes of the chemicals species. For example, the dielectric properties can increase or decrease as temperature changes or as the phase of the chemical goes from liquid to solid. The dielectric properties of any solvent, reactant, inert material or catalyst can change with temperature and with a change of phase, also. The dielectric properties of the macroscopic artificial dielectric (MAD) susceptor system are effected by the polar and non-polar material in solid, liquid and gas states of matter.

Furthermore, the dielectric properties of a catalyst and inert materials are effected by the wavelength of the applied electromagnetic energy.

Furthermore, dielectric properties are dependent on the wavelength or wavelengths of applied energy. Applied wavelengths can be infra-red, visible, microwave, radio frequency or any combination of these types of wavelengths categories. Moreover, sunlight is an example of a source having more than one type of applied electromagnetic energy; the same is true an incandescent light bulb.

Moreover, methods to create products from reactants with applied electromagnetic energy have been disclosed. Materials and materials structures with and without catalysts using applied electromagnetic energy have been disclosed. One such structure is known as a macroscopic artificial dielectric structure. Dalton, discloses such technology, methods and applications in U.S. Pat. Nos. 7,714,258; 7,176,427; 7,129,453; 6,572,737; 6,891,138; 6,512,215; 6,380,525; and 6,271,509

Moreover, macroscopic artificial dielectric susceptor systems are unique. They can produce biochemical efficiency and lower cost.

### BRIEF SUMMARY OF THE INVENTION

This presents invention in the broadest sense includes methods, processed and devices to create biochemicals using macroscopic artificial dielectric (MAD) susceptor systems with applied electromagnetic energy.

Dalton U.S. Pat. No. 7,714,258; 7,176,427; 7,129,453; 6,572,737; 6,891,138; 6,512,215; 6,380,525; and 6,271,509 are incorporated as a references here within.

This invention can use one or more steps or multiple steps in a method, process or device to create at least one biochemical that is produced from at least one biochemical reactant. Each step can contain a MAD susceptor system that is configured for specific reaction or reactions that will produce a desired product or process with the chosen applied electromagnetic energy for each step. Furthermore, each step can have more than one part (or stage).

Moreover, biochemicals that are products can be used as drop-in fuels, can be used as drop-chemical substitutes, can be used as drop-in feedstock at petroleum refineries, can be used as substitute chemicals for other products and processes or can be a finished commercial or finished industrial product.

### DETAILED DESCRIPTION OF INVENTION

In the broadest aspect of this invention, at least one biochemical product is made from a reactant chemical species flow containing at least one reactant that is a bio-chemical derived from biomass where the chemical species flow passes through a specifically configured macroscopic artificial dielectric (MAD) susceptor system with a specific structure and specific materials and with chosen applied electromagnetic energy for a specific type of chemical reaction. Various processes, methods and devices utilized to make bio-chemicals.

Another aspect of this invention is that biochemicals can be obtained from biomass as solids, liquids and gases. Biochemicals that are derived from biochemicals can be a finish product or a reactant for another reaction to produce a finish product that a biochemical or product that contains a biochemical. A biochemical is a chemical that is obtain from biomass or originally obtain from biomass.

Another aspect of this invention is that process reactions (or functions) include dewatering, cracking, demetallization, desulfurization, dehydration, isomerization, oxidation of alcohols, deoxygenation, decarboxylation, regenerating coke, isomerization, hydrotreating, dehydroxylation, Fisher-Tropsch synthesis, methanization, reforming, pyrolysis, catalytic pyrolysis, aqueous phase reforming, separation of chemical species, hydrodeoxylation with catalyst reforming, alkylation and evaporation.

Another aspect of this invention is that all or at least a part of said reactants are derived from biomass in a process.

Another aspect of the invention is that the macroscopic artificial dielectric susceptor system is designed as a specifically designed macroscopic artificial dielectric susceptor structure so that the MAD structure has for at least one specific function of chemical reaction. The specific functions of chemical reaction include dewatering, cracking, demetallization, desulfurization, dehydration, isomerization, oxidation of alcohols, deoxygenation, decarboxylation, regenerating coke, isomerization, hydrotreating, dehydroxylation, Fisher-Tropsch synthesis, methanization, reforming, pyrolysis, aqueous phase reforming, separation of chemical species, distillation and evaporation. Other function include catalysis, interaction with the reactants.

Another aspect of this invention is that macroscopic artificial dielectric structure contains a solid catalyst that is used for a specific function of chemical reaction. The specific functions of the catalyst of chemical reaction include dewatering, cracking, demetallization, desulfurization, dehydration, isomerization, oxidation of alcohols, deoxygenation, decarboxylation, regenerating coke, isomerization, hydrotreating, dehydroxylation, Fisher-Tropsch synthesis of syngas, methanization, reforming, pyrolysis, aqueous phase reforming, separation of chemical species, reactive distillation, and evaporation.

Another aspect of this invention is that these said reaction functions can be carried out in the presence of hydrogen. The hydrogen can be formed in-situ, introduced as a reactant, provide as a reaction product in the MAD susceptor system. Hydrogen can be recycled into a method, process or device. These reaction functions in the presence of hydrogen include hydro-dewatering, hydrocracking, hydrodemetallization, hydrodesulfurization, dehydration, hydroisomerization, hydrooxidation of alcohols, hydrodeoxygenation, hydrodecarboxylation, hydroregenerating coke, hydrotreating, hydrodehydroxylation, Fisher-Tropsch synthesis of syngas, hydromethanization, hydroreforming, hydropyrolysis, aqueous phase hydroreforming, separation of chemical species, reactive hydrodistillation, and evaporation. Another aspect of this invention is that prior to any process, any reactants entering the MAD susceptor system, one or more of the following processes or method can occur: a separation process or method; a distillation process or method; a recycling process or method where a product or products that were synthesized from another process are recycled and then mix with the chemical species flow of reactants prior to entering the MAD susceptor system; a recycling process or method where least one unreacted reactants from the previous chemical species flow that had passed through the MAD susceptor system is recycled and then recycled unreacted material is mixed with the fresh chemical species flow prior to entering the MAD susceptor system; a recycling process or method where a portion of the products from a previous passing of a reactant chemical species that had passed through the MAD susceptor systems is recycled and then the recycled products are mixed the fresh chemical species flow prior to entering the MAD susceptor system; a recycling process or method where unreacted reactants from another process is recycled and then the recycled reactants are mixed with the chemical species flow of reactants prior to entering the MAD susceptor system; or a combination of more than one of these processes or methods.

Another aspect of this invention is that gases can be a reactant or an inert chemical in the chemical species flow. These gases can include including CO, CO2, steam, water, methane or another hydrocarbon can be used in the MAD susceptor system in a method, process, or device.

Another aspect of this invention the process can employ different types of atmospheres. Reducing atmospheres. Oxidizing atmospheres, atmospheres with elevated pressures and vacuums can be employed in the methods, processes or devices.

Another aspect of this invention is that one or more than one reactant can enter the MAD susceptor system at elevated temperatures that are above room temperature.

Another aspect this invention is that more than one step can occur in a method or process. Each step can have a different MAD susceptor system and different MAD structure. Furthermore, each step can have different conditions of temperature and pressure. Each step can use different materials for the MAD susceptor system, different types of electromagnetic energy, a different frequency of electromagnetic energy, and a different configuration of materials for the MAD susceptor system, a different amount of intensity of applied electromagnetic energy, a different type of catalysts and different amounts of catalyst.

Another aspect of the invention is that each step can contain different stages where each stage is configured with a specifically designed MAD susceptor system for specific reactions to produce at least one desired biochemical product or a larger quantity of desired biochemical product from at least one biochemical reactant in the chemicals species flow with the chosen applied electromagnetic energy for each stage.

Another aspect this invention is that each stage in a step of a method or process can be different. Each stage can have a different MAD susceptor system and different MAD structure. Furthermore, each stage can have different conditions of temperature and pressure. Each stage can use different materials for the MAD susceptor system, different types of electromagnetic energy, a different frequency of electromagnetic energy, and different configurations of materials for the MAD susceptor system, different amount of intensity of applied electromagnetic energy, different types of catalysts and different amounts of catalyst.

Another aspect of this invention is the improve of the commercial value of oxygenated-biochemicals that were derived from biomass.

Another aspect of this invention is that methods are employed to break the lignin structure. These methods include mechanical methods, chemical methods, high-pressure methods, thermal methods, and mild pyrolysis conditions. Moreover, mild pyrolysis conditions can be co-employed with hydrolysis synthesis to extract and synthesize bio-oils. Mild pyrolysis conditions can disrupt biopolymers in the biomass so as used to extract sugar for further pyrolysis. One or a combination of these methods can improve the extraction efficiency of sugars and pyrolysis oil from the solid biomass. The extraction efficiency of sugars from biomass can be improved by chemical means and steam-explosion means.

Another aspect of this invention is that sugars are extracted from biomass, and these sugars can be reactions to make biochemicals. These sugars include C5 sugars (xylose, arabinose, etc) C6 Sugars (mannose, glucose, fructose, galactose, etc), multiple oligo-saccharides, monosaccharides, disaccharides, trisaccharides, starches and other carbohydrates

Another aspect of this invention is that a gas can be used for reactions to occur. Often hydrogen is need for hydrotreatments. Other gases such as methane, carbon monoxide and others are used as reactants in a refining the bio-oil constituents into biochemicals products to remove oxygen.

Another aspect of this invention is that a process can treat pyrolysis oil to address the water content of the pyrolysis oil. The pyrolysis oils can differ in hydrocarbons in water soluble phases, and this water can be remove by separation techniques such distillation, separation of the water into water-phases where one phase contains more soluble bio-chemicals and another phase contains less soluble biochemical.

Another aspect of this invention is that biomass, biofeedstock and biochemicals can be coprocess. OFPA's, pyrolysis oils, sugars, alcohols, and aqueous-phase-reformed-biochemicals can be co-processed to form at least on new biochemical species as a desired product for commercial or industrial uses.

Another aspect of this invention is that biochemical products can have commercial and industrial value. Biochemicals products can be used as drop-in fuels, can be used as drop-chemical substitutes, can be used as drop-in feedstock at petroleum refineries, and can be used as substitute chemicals for other products and processes. Biochemicals of higher value such as BTX (benzene-toluene-xylene) can be created.

Another aspect of this invention is that co-process of biomass feedstock and biochemicals requires a process or processes with a functions that addresses the different chemical structure biomass feedstock and biochemicals. The chemical structures of the feedstock of biomass, pyrolysis oils, OFPA's, and sugars differ greatly. More than one process may be required to create desired biochemical products as commercial and industrial products. The structure of biomass feedstocks can vary greatly, and the biochemical products from the different feedstocks are structurally different, too.

For example, OFPA's typically have straight longer chain molecules that are used as reactants, where pyrolysis oils have a greater quantity of cyclic compounds which are produce in the first use of lignocellulose biomass as the initial feedstock. Subsequently, the pyrolysis oil can be used as a feedstock to produce other biochemicals by various processes producing a refined product or new chemicals species for a desired commercial use.

Another aspect of this invention is that both primary and secondary feeds stocks often need separation techniques and pretreatment processes to break cell walls so that chemical species are more readily available for other processes, remove solids, remove water, sulfur, metals and other chemical species. Several techniques can accomplish these tasks including distillation techniques, absorption techniques, demetallization techniques, hydrotreatment techniques include desulfurization, demetallization cracking and others.

Another aspect of this invention is that biochemicals can be produced by solid biomass is called thermal pyrolysis (or pyrolysis or depolymerization). Pyrolysis is used with solid biomass. Pyrolysis produces solid, liquids and gas including water and liquids with acidic properties.

Another aspect of this invention is that biochemicals can be produced by pyrolysis methods that use catalysts, and this method is called catalytic pyrolysis.

Another aspect of this invention is that biomass initial feedstocks can include whole solid biomass, wood, sugars, animal fats, free fatty acids (FFA's), starches, pyrolysis oils, plant oils, triglycerides, diglycerides, monoglycerides, glycerin, char, alcohols, biogas, other bio-derived hydrocarbons, bio-derived hydrogen, bio-derived carbon monoxides and other bio-derived oxygenates.

Another aspect of this invention is that the initial feedstock can include other organic materials including recycled plastic, tires, sawdust, polypropylene, polyethylene, a petroleum fraction of chemicals and similar organic materials.

Another aspect of this invention is that OFPA's, pyrolysis oils, and aqueous-phase-reformed-biochemicals can be co-processed to form at least on new biochemical species as a desired product for commercial or industrial uses. Such process can employ hydrodeoxylation-catalytic reforming methods

Another aspect of this invention is that the macroscopic artificial dielectric susceptor system can consist of biomass, inorganic catalyst, inorganic inert materials, inorganic heat carriers, a liquid solvent that is polar, a liquid solvent that is not polar, a gas or combination of thereof. Furthermore, the biomass can be in one more states of matter chosen from the state of matter consisting of a solid, liquid, gas or plasma.

Another aspect of this invention that at least one region of the macroscopic artificial dielectric susceptor system is constructed of an inorganic material or a material that is an organic polymer structure that is thermally and chemical stable in the artificial dielectric susceptor system above 150° C. Furthermore, this inorganic material can be selected from one or more material that is a catalytic material, inert material, a heat carrier material, an artificial dielectric susceptor material, a material that contains a field concentrator, fluoropolymer, polypropylene, a silicone, a composite material or a combination thereof.

Another aspect of this invention is that a heat from the source of applied electromagnetic energy can be used to heat one or more of the reactants prior to the entering the MAD susceptor system and being exposed to the applied electromagnetic energy.

Another aspect of this invention is that the regions with solid materials in the structure of the MAD susceptor system can be solid materials chosen for their transmission, absorption or reflective properties with respect to the applied electromagnetic energy.

Another aspect of this invention is that the MAD susceptor system may be dielectrically dynamic. Dielectrically dynamic means that the dielectric properties of the MAD susceptor system changes. The change in dielectric properties can be due to reactants becoming products, and a phase change of a chemical species or phase change of a solid chemical species that includes an inorganic catalysts, an inert material or heat carrier. Furthermore, the dynamic dielectric properties can be due to a material being exposed to higher pressures, higher apparent temperatures, different types of electromagnetic energy, different frequencies of the same type of electromagnetic energy, different intensity of the power of the applied electromagnetic energy. The chemical or material can be in liquid, solid or gaseous forms. The different pressure, different temperature, different type of electromagnetic energy, different frequency of the same type of electromagnetic energy or different intensity of the applied electromagnetic energy can occur as the chemical species flow travels from on step to the next step or with one stage (part) to the next stage (part) in a step.

Another aspect of this invention is the in-situ formation of a solid carbon species by a reactant that was part of the initial solid biomass. The in-situ formation of the solid carbon species changes the dielectric properties of the MAD susceptor system. In-situ carbon and In-situ carbon-containings solids can be removed from the method, process or device prior to entering another part or stage prior to the next part or stage.

Another aspect of this invention is in-situ formation of ash. The in-situ formation of ash can change the dielectric properties of the MAD susceptor system and the catalytic properties of the MAD susceptor. The catalytic properties of the in-situ ash formation can cause new produces to be unstable. In some aspects it may be desirable for the in-situ ash formation to be present during reaction conditions while other times the ash may be undesirable for reaction condition. Additionally, metallic ions added to the ash to act as catalysts. Moreover, the in-situ ash can be remove from the process, method or device prior to the next step or stage.

Another aspect of this invention is superflash pyrolysis. Certain types of electromagnetic energy and certain amounts of electromagnetic energy can be used to cause superflash pyrolysis.

Another aspect of this invention is superflash reactions. Certain types of electromagnetic energy and certain amounts of electromagnetic energy can be used to cause superflash reactions.

Another aspect of this invention is to include a solid material in the MAD system to increase the depth of penetration of the applied electromagnetic energy.

Another aspect of this invention is to include a liquid material in the MAD system to increase the depth of penetration of the applied electromagnetic energy.

Another aspect of this invention is to include a gas species in the MAD system to increase the depth of penetration of the applied electromagnetic energy.

Another aspect of this invention is to include a liquid material in the MAD system can be used to increase the absorption of applied electromagnetic energy of the applied electromagnetic energy.

Another aspect of this invention that the particle size of the solid constiuents of the structure of the MAD susceptor system is control the dielectric properties of the MAD susceptor system by changing the particle size of one of the solid constituents of the MAD system including a solid that is biomass or is derived from solid biomass.

Another aspect of this invention is that the MAD susceptor system can be comprised of a solid material containing a pseudomorphic structure or a solid material containing a partially pseudomorpic structure.

Another aspect of this invention is that the one or more reactant can act as the part of the artificial dielectric susceptor. The same is true for products.

Another aspect of this invention is that the biochemicals can be derived from biomass in all phases of matter for materials: liquid, solid or gas. One, more than one phase or all phases can be created in a method, process or device to produce biochemical products from biochemical reactants where the original biochemicals were derived direction from biomass.

Another aspect of this invention is that more than one method, process or device can be in serial communication to create desired products from reactants.

Another aspect of this invention is that one or more wavelength of applied electromagnetic energy can be applied to a macroscopic artificial dielectric susceptor system.

Another aspect of this invention is that on or more intensity of a wavelength of applied electromagnetic energy can be applied to a macroscopic artificial dielectric susceptor system.

Another aspect of this invention is that one or more wavelengths of electromagnetic energy of a type of electromagnetic can be applied to the macroscopic artificial dielectric susceptor system. The these types of radiation of electromagnetic energy consisting of infrared radiation, radio frequency radiation, ultraviolet radiation, microwave radiation, visible range radiation, a mixed of radiation types from a single source of electromagnetic energy or a combination thereof. For example, mix radiation types from a single source of electromagnetic energy include light bulbs as well as the sun.

Another aspect of this invention is that after each part, stage or step of a method, process or device, effluent, products, and/or chemical species can be removed before the next stage or next part of each step in method, process or device.

Another aspect of this invention is that the MAD susceptor system can use of heat carrier materials to synthesize a biochemical. The heat carrier can be organic or inorganic. The heat carrier can contain a catalyst. The heat carrier can have the heat generated in-situ by the applied electromagnetic energy.

The heat carrier can be artificial dielectric material.

Another aspect of this invention is that algae can be used as sources of biomass. Lipids and other organic solid biomass can be turned into fuels.

Another aspect of this invention is that Hemp can be used a source of biomass.

Another aspect of this invention is the use of lignocellulose material the industrial hemp (Cannabis sativa L.) as a source of biomass for biochemicals. This include using the lignin, cellulose, hemicellulose materials separately as a raw material. This include using the bast fibers and the stalk fibers separately as a source of biomass to produce biochemicals.

Another aspect of this invention is the use of different varieties of hemp (cannabis) as a source of biomass for biochemicals. This includes the use of cannabis varieties including Sativa, Indica and Hybrids of Sativa and Indica.

Furthermore, the hemp oil from seeds of these varieties can be used as a source of biomass for biochemicals. Hemp oils and hemp lignocellulose can be co-processed to product biochemicals.

Another aspect of this invention is that graphene can be produced by processing the bast fibers of hemp plants. Other products can be produced such carbon species including nanomaterials, bio-supercapacitors materials, bio-energy storage materials for batteries, carbon nanosheets, carbon nanofibers, carbon nanomaterials and graphene.

Another aspect of the is invention is that The invention is directed to a method of producing hydrogen via the reforming of an oxygenated hydrocarbon feedstock. The method comprises reacting water and a water-soluble oxygenated hydrocarbon having at least two carbon atoms, in the presence of a metal-containing catalyst. The catalyst comprises a metal selected from the group consisting of Group VIII transitional metals, alloys thereof, and mixtures thereof.

In one aspect of this invention, this presents invention in the broadest sense includes methods, processed and devices to create biochemicals using macroscopic artificial dielectric (MAD) susceptor systems with applied electromagnetic energy.

Another aspect of this invention is a process for creating at least one biochemical product from at least one chemical species that is a reactant originated from biomass where the reactant is part of a chemical species flow comprising passing the chemical species flow through a macroscopic artificial dielectric susceptor system having a structure that is a gas-permeable susceptor, and subjecting the structure to at least one wavelength of applied electromagnetic energy, the structure consisting of at least two regions where first regions and second regions are solid materials, the second regions contain a solid catalytic material, the first regions and the second regions having different dielectric properties to at least one wavelength of the applied electromagnetic energy, the dielectric properties of the first regions being greater than the depth of penetration of the second regions, wherein:
(a) the first regions are discontinuously interspersed at least a certain distance from each other between and among the second regions,
(b) the transmission of the applied electromagnetic energy by the first regions provides a means for increase interaction between the applied electromagnetic energy and the chemical species flow
(c) the transmission of the applied electromagnetic energy by the first regions provides a means for increased interaction between the applied electromagnetic energy and the second regions in the gas-permeable susceptor to interact with the catalyst of the second regions, and
(d) the distance between each of the first regions and a volume fraction of the structure that the first regions make up assists the applied electromagnetic energy to penetrate the structure and to interact volumetrically with the susceptor and the chemical species flow passing through the susceptor

and allows for the synthesis of at least one new biochemical species that is created by catalysis from interaction with the second regions.

Another aspect of this invention is that the macroscopic artificial dielectric system further comprises of 3^{rd} regions that are solid materials.

Another aspect of this invention is that 3^{rd} regions are made of solid materials that are heat carriers.

Another aspect of this invention is that the solid material of the 3^{rd} region is selected from the group of materials selected from a metal, a ceramic, a carbide, nitride, boride, a metal alloy, an oxide, an artificial dielectric susceptor, a materials with Curie point, a sulfide, a sulfate, fluoropolymer composite, polypropylene composite, a silicone composite, a material that can radiate at least one wavelength of infra-red wavelengths when said material has first absorbed at least one wavelength of applied electromagnetic energy, a material that can radiate at least wavelength of infra-red wavelengths when said material has first absorbed at least one wavelength of applied electromagnetic energy, a clay material, a material with a talc structure, an inorganic material with a pseudomorphic structure, an material containing a field concentrator, an electromagnetic susceptor with a coating, an electromagnetic susceptor of sintered ceramic materials, a materials that has attrition properties as an abrasive, or a combination thereof.

Another aspect of this invention is that the 3^{rd} regions are solid biomass that are solid reactants where the solid biomass is selected group of solid biomass consisting of a lignin material, a lignocellulose material, a sugar, cellulose, hemicellulose, a char product or a combination there of.

Another aspect of this invention is that the 3^{rd} regions consist of a solid catalytic material.

Another aspect of this invention is that the solid catalytic material in the 3^{rd} regions contains a support material.

Another aspect of this invention is that the solid catalyst in the 2^{nd} Regions contains a support material.

Another aspect of this invention is that the catalyst used in the 3^{rd} regions is a different catalyst for a different function compared to the different catalyst used in the second regions where the catalyst in the second regions has a different function.

Another aspect of this invention is that the catalyst in the 3^{rd} regions has the same function as the catalyst in the 2^{nd} regions but the catalyst in 3^{rd} regions is a different catalytic material as compared to the catalytic material of the catalyst in the 2^{nd} Region.

Another aspect of this invention is that the solid catalyst in 2^{nd} regions has a function that is selected from the group of functions consisting of dewatering, cracking, demetallization, desulfurization, dehydration, isomerization, oxidation of alcohols, deoxygenation, decarboxylation, regenerating coke, isomerization, hydrotreating, dehydroxylation, Fisher-Tropsch synthesis of syngas, methanization, reforming, pyrolysis, aqueous phase reforming, separation of chemical species, reactive distillation, hydro-dewatering, hydrocracking, hydrodemetallization, hydrodesulfurization, dehydration, hydroisomerization, hydrooxidation of alcohols, hydrodeoxygenation, hydrodecarboxylation, hydroregenerating coke, hydrotreating, hydrodehydroxylation, Fisher-Tropsch synthesis of syngas, hydromethanization, hydroreforming, hydropyrolysis, aqueous phase hydroreforming, separation of chemical species, reactive hydrodistillation, liquid phase separation, a Diels-Alder reaction, a aldol condensation reaction, Michael addition reaction, a Robinson annulation reaction and evaporation.

Another aspect of this invention is that the solid catalyst in the 3^{rd} regions has a function that is selected from the group of functions consisting of dewatering, cracking, demetallization, desulfurization, dehydration, isomerization, oxidation of alcohols, deoxygenation, decarboxylation, regenerating coke, isomerization, hydrotreating, dehydroxylation, Fisher-Tropsch synthesis of syngas, methanization, reforming, pyrolysis, aqueous phase reforming, separation of chemical species, reactive distillation, hydro-dewatering, hydrocracking, hydrodemetallization, hydrodesulfurization, dehydration, hydroisomerization, hydrooxidation of alcohols, hydrodeoxygenation, hydrodecarboxylation, hydroregenerating coke, hydrotreating, hydrodehydroxylation, Fisher-Tropsch synthesis of syngas, hydromethanization, hydroreforming, hydropyrolysis, aqueous phase hydroreforming, separation of chemical species, reactive hydrodistillation, liquid phase separation, a Diels-Alder reaction, a aldol condensation reaction, Michael addition reaction, a Robinson annulation reaction and evaporation.

Another aspect of this invention is that the applied electromagnetic energy has a type of radiation that is selected from the group of types of radiation of electromagnetic energy consisting of infrared radiation, radio frequency radiation, ultraviolet radiation, microwave radiation, visible range radiation, a mixed of radiation types from a single source of electromagnetic energy, pulsed, variable frequency, continuous or a combination thereof.

Another aspect of this invention is that the applied electromagnetic energy is two or more wavelengths of applied electromagnetic energy that is selected from the same type of radiation.

Another aspect of this invention is that The applied electromagnetic energy as in claim 1 wherein two or more wavelengths of electromagnetic energy is selected from different types of radiation.

Another aspect of this invention is that The macroscopic artificial dielectric susceptor system having a function as in claim 1, wherein the function of the macroscopic artificial dielectric susceptor system is selected from the group of functions consisting of dewatering, cracking, demetallization, desulfurization, dehydration, isomerization, oxidation of alcohols, deoxygenation, decarboxylation, regenerating coke, isomerization, hydrotreating, dehydroxylation, Fisher-Tropsch synthesis of syngas, methanization, reforming, pyrolysis, aqueous phase reforming, separation of chemical species, reactive distillation, hydro-dewatering, hydrocracking, hydrodemetallization, hydrodesulfurization, dehydration, hydroisomerization, hydrooxidation of alcohols, hydrodeoxygenation, hydrodecarboxylation, hydroregenerating coke, hydrotreating, hydrodehydroxylation, Fisher-Tropsch synthesis of syngas, hydromethanization, hydroreforming, hydropyrolysis, aqueous phase hydroreforming, separation of chemical species, reactive hydrodistillation, liquid phase separation a Diels-Alder reaction, a aldol condensation reaction, Michael addition reaction, a Robinson annulation reaction, and evaporation.

Another aspect of this invention is that Process as in claim 1, wherein the function of the process for chemical reaction is selected from the group of functions consisting of dewatering, cracking, demetallization, desulfurization, dehydration, isomerization, oxidation of alcohols, deoxygenation, decarboxylation, regenerating coke, isomerization, hydrotreating, dehydroxylation, Fisher-Tropsch synthesis of syngas, methanization, reforming, pyrolysis, aqueous phase reforming, separation of chemical species, reactive distillation, hydro-dewatering, hydrocracking, hydrodemetallization, hydrodesulfurization, dehydration, hydroisomerization, hydrooxidation of alcohols, hydrodeoxygenation, hydrodecarboxylation, hydroregenerating coke, hydrotreating, hydrodehydroxylation, Fisher-Tropsch synthesis of syngas, hydromethanization, hydroreforming, hydropyrolysis, aqueous phase hydroreforming, separation of chemical species, reactive hydrodistillation, liquid phase separation, a Diels-Alder reaction, a aldol condensation reaction, Michael addition reaction, a Robinson annulation reaction and evaporation.

Another aspect of this invention is that The process as in claim 1, wherein the said process is carried in a reactor device selected from the group reactor devices consisting of a fixed bed reactor, a fluidized catalystic cracker, a riser reactor, a slurry reactor, a plug flow reactor, a continuously stirred reactor, a batch reactor, a high pressure reactor, bubble column reactor, a semi-batch reactor, catalytic reactor, fuidized bed reactor, trickle-bed reactor, a triphase reactor, a cyclonic reactor, a catalytic cyclonic reactor, multiphase reactor, a tubular flow reactor, tri phase reactor, slurry column reactor, three phase bubble reactor, slurry phase bubble column reactor, artificial dielectric device and a combination thereof.

Another aspect of this invention is that The applied electromagnetic energy as in claim 1, wherein the applied electromagnetic energy contains two applied wavelengths where first wavelength is chosen from a microwave wavelength that interacts with the catalytic material of the 2^{nd} Regions and the second wavelength is chosen from an infra-red wavelength for primary interaction with the chemical species flow.

Another aspect of this invention is that The applied electromagnetic energy as in claim 1, wherein the applied electromagnetic energy contains two applied wavelengths where first wavelength is chosen from a microwave wavelength that interacts with the catalytic material of the 2^{nd} Regions and the second wavelength is chosen from the radio frequency wavelength for primary interaction with the chemical species flow.

Another aspect of this invention is that The applied electromagnetic energy as in claim 1, wherein the applied electromagnetic energy contains two applied wavelengths where first wavelength is chosen from a microwave frequency that interacts with the catalytic material of the 2^{nd} Regions and the second wavelength is chosen from an radio frequency wavelength for primary interaction with the solid biomass in the 3^{rd} regions.

Another aspect of this invention is that The applied electromagnetic energy as in claim 1, wherein the applied electromagnetic energy contains more than two applied wavelengths where first wavelength is chosen from a microwave wavelength that interacts with the catalytic material of the 2^{nd} Regions and the remaining wavelengths are chosen from an infra-red wavelength for primary interaction with the chemical species flow.

Another aspect of this invention is that The solid catalytic material of the 3^{nd} region as in claim 6, wherein solid catalytic materials of the 3^{nd} region is select from the group of solid catalytic materials select from the group of catalyst consisting of a clay, a zeolite, metal, an alumina material, a silica material, a carbonate, a sulfide, a sulfate, a hydroxide, a cation doped material, and anion doped material, a precious metal, Pt, d, Ag, a pseudomorphic materials, an artificial dielectric susceptor, a materials with a coating, a materials with a Curie pt., a metal hydride, an interstitial metal hydride, a carbon species or combination thereof.

Another aspect of this invention is that The chemical species flow as in claim 1 wherein the chemical species flow contains liquid that has polar molecules that absorb at least one wavelength of the applied electromagnetic energy

Another aspect of this invention is that The chemical species flow as in claim 1 wherein the chemical species flow contains a liquid that has non-polar molecules that has very low absorption of at least on wavelength of the applied electromagnetic energy.

Another aspect of this invention is that The chemical species flow as in claim 1 wherein the chemical species flow contains a gas that has polar molecules that absorb at least one wavelength of the applied electromagnetic energy

Another aspect of this invention is that The solid catalytic material of the 2^{nd} region as in claim 1, wherein solid catalytic materials of the 2^{nd} region is select from the group of solid catalytic materials consisting of a clay, a zeolite, metal, an alumina material, a silica material, a carbonate, a sulfide, a sulfate, a hydroxide, a cation doped material, and anion doped material, a precious metal, Pt, d, Ag, a pseudomorphic materials, a metal hydride, an interstitial metal hydride, a material that has a support, a material with a Curie Pt., a materials that has a coating, and artificial dielectric susceptor, a carbon species or combination thereof.

Another aspect of this invention is that The biomass as in claim 1 where the biomass is a variety of hemp.

Another aspect of this invention is that, preferably, the first regions are a material chosen from the group consisting of a ceramic, a glass, an organic polymer, polypropylene, polycarbonate, a fluorinated hydrocarbon, Teflon, fused silica, a dielectric loss ceramic, a low dielectric loss glass, a low dielectric loss porcelain, a clay, materials with a low dielectric loss and low dielectric constant, aerogel, a foam, and combinations thereof.

Another aspect of this inventions is that the first regions preferably are shaped in a form selected from the group consisting of shapes of a irregular shaped granular, a spiral-like, spherical, orthogonal, twist-like, chiral shape, spire-like shape, cylindrical shape, tubular shape, helical shape, rod-like shape, plate-like shape, acicular shape, spherical shape, ellipsoidal shape, disc-shaped shape, irregular-shaped shape, plate-like shape, needle-like shape, twist shape, a shape like a pasta rotini twist and combination thereof. The size of the first regions preferably are between 0.00001 and 30 meters. The volume fraction of the first regions preferably is greater than 5%.

Another aspect of this invention is that the first regions preferably are arranged in a 3-dimension array consisting of an array structure selected from the group consisting of at least one homogenous distribution, at least one random distribution, at least one inhomogeneous, and a combination there of.

Another aspect of this invention is that The invention further is a biochemical product created by a process where a chemical species flow passes through a macroscopic artificial dielectric structure for a gas-permeable susceptor consisting of first regions in the structure that are primarily transparent to applied electromagnetic energy and second regions in the structure that contain a solid catalyst that interacts with the applied electromagnetic energy; wherein: (a) the first regions are discontinuously interspersed between and among the second regions, (b) the transmission of the applied electromagnetic energy by these said first regions provides a means for increase interaction between the applied electromagnetic energy and the chemical species flow, (c) the transmission of the applied electromagnetic energy by these said first regions provides a means for increased interaction between the applied electromagnetic energy and the second regions in the gas-permeable susceptor to interact with said second regions, and (d) the distance between each of said first regions and volume fraction of the said first regions assists the applied electromagnetic energy to penetrating the structure and interacting volumetrically with the susceptor and the reactant chemical species flow passing through the susceptor and allows for the synthesis of a biochemical product.

Another aspect of this invention is that the invention further is a biochemical product created by a process where a chemical species flow passes through a macroscopic artificial dielectric structure for a gas-permeable susceptor consisting of: first regions in the structure that are primarily absorptive to applied electromagnetic energy; second regions in the structure that are a solid catalyst material that interacts with the applied electromagnetic energy; wherein: (a) the first regions are discontinuously interspersed between and among the second regions, (b) the transmission of the applied electromagnetic energy by these said first regions provides a means for increase interaction between the applied electromagnetic energy and the chemical species flow, (c) the transmission of the applied electromagnetic energy by these said first regions provides a means for increased interaction between the applied electromagnetic energy and the second regions in the gas-permeable susceptor to interact with said second regions, and (d) the distance between each of said first regions and volume fraction of the said first regions assists the applied electromagnetic energy to penetrating the structure and interacting volumetrically with the susceptor and the reactant chemical species flow passing through the susceptor and allows for the synthesis a biochemical product.

Another aspect of the this invention is the process is carried in a reactor device selected from the group reactor devices consisting of a fixed bed reactor, a fluidized catalytic cracker, a riser reactor, a slurry reactor, a plug flow reactor, a continuously stirred reactor, a batch reactor, a high pressure reactor, bubble column reactor, a semi-batch reactor, catalytic reactor, fluidized bed reactor, trickle-bed reactor, a triphase reactor, a cyclonic reactor, a catalytic cyclonic reactor, multiphase reactor, a tubular flow reactor, tri phase reactor, slurry column reactor, three phase bubble reactor, slurry phase bubble column reactor, artificial dielectric device and a combination thereof.

Another aspect of the this invention is the method is carried in a reactor device selected from the group reactor devices consisting of a fixed bed reactor, a fluidized catalytic cracker, a riser reactor, a slurry reactor, a plug flow reactor, a continuously stirred reactor, a batch reactor, a high pressure reactor, bubble column reactor, a semi-batch reactor, catalytic reactor, fluidized bed reactor, trickle-bed reactor, a triphase reactor, a cyclonic reactor, a catalytic cyclonic reactor, multiphase reactor, a tubular flow reactor, tri phase reactor, slurry column reactor, three phase bubble reactor, slurry phase bubble column reactor, artificial dielectric device and a combination thereof.

Another aspect of the this invention is the device comprising a macroscopic artificial dielectric structure for a gas-permeable susceptor for subjecting the chemical species flow to applied electromagnetic energy is a reactor device selected from the group reactor devices consisting of a fixed bed reactor, a fluidized catalytic cracker, a riser reactor, a slurry reactor, a plug flow reactor, a continuously stirred reactor, a batch reactor, a high pressure reactor, bubble column reactor, a semi-batch reactor, catalytic reactor, fluidized bed reactor, trickle-bed reactor, a triphase reactor, a cyclonic reactor, a catalytic cyclonic reactor, multiphase reactor, a tubular flow reactor, tri phase reactor, slurry column reactor, three phase bubble reactor, slurry phase bubble column reactor, artificial dielectric device and a combination thereof.

Another aspect of the this invention is a process wherein the distance between each of the first regions and a volume fraction of the structure that the first regions make up assists the applied electromagnetic energy to penetrate the structure and to interact volumetrically with the susceptor and the chemical species flow to a greater extent in the combined volume of the first regions, the second regions and the chemical species flow when compared to the penetration of the applied electromagnetic energy in the combined volume of either the second regions and the chemical species flow or only the chemical species flow as the chemical species flow passes through the first regions and allows for the synthesis of at least one new biochemical species that is created by catalysis from interaction with the second regions.

Another aspect of the this invention is a process wherein the physical arrangement and volume fraction of the first regions of the susceptor creates a greater surface area for interaction between the applied electromagnetic energy and any secondary electromagnetic energy produced from the interaction of the applied electromagnetic energy with either the solid material of first regions, the catalyst that is a solid material in second regions, the chemical species flow, the useful energy product or any combination thereof, and the chemical species flow to a greater extent in the combined volume of the first regions, the second regions and the chemical species flow when compared to the penetration of the applied electromagnetic energy in the combined volume of either the second regions and the chemical species flow or only the chemical species flow as the chemical species flow passes through the first regions and allows for the synthesis of at least one new biochemical species that is created by catalysis from interaction with the second regions.

9. Another aspect of the this invention is a system for creating a biochemical from a chemical species flow, the system comprising: a macroscopic artificial dielectric structure for a gas-permeable susceptor, the structure consisting of first regions being a solid material and second regions being a catalyst that is a solid material, the first regions and the second regions having different depths of penetration of applied electromagnetic energy, the depth of penetration of the first regions being greater than the depth of penetration of the second regions that are a solid with catalytic properties, and flowing the chemical species flow through the gas-permeable susceptor, and subjecting the chemical species flow and catalysts of the second regions to the applied electromagnetic energy within the structure, wherein: (a) the first regions are discontinuously interspersed at least a certain distance from each other between and among the second regions, (b) the transmission of the applied electromagnetic energy by the first regions provides a means for increase interaction between the applied electromagnetic energy and the chemical species flow (c) the transmission of the applied electromagnetic energy by the first regions provides a means for increased interaction between the applied electromagnetic energy and the catalyst of second regions in the gas-permeable susceptor to interact with the catalyst in the second regions, and (d) the distance between each of the first regions and a volume fraction of the structure that the first regions make up assists the applied electromagnetic energy to penetrate the structure and to interact volumetrically with the susceptor and the chemical species flow passing through the susceptor and allows for the synthesis of at least one new biochemical species that is created by catalysis from interaction with the second regions.

Another aspect of this invention is a system wherein the distance between each of the first regions and a volume fraction of the structure that the first regions make up assists the applied electromagnetic energy to penetrate the structure and to interact volumetrically with the susceptor and the chemical species flow to a greater extent in the combined volume of the first regions, the catalyst in the second regions and the chemical species flow when compared to the penetration of the applied electromagnetic energy in the combined volume of either the second regions and the chemical species flow as the chemical species flow passes through the first regions and allows for the synthesis of at least one new biochemical species that is created by catalysis from interaction with the second regions

Another aspect of the invention is a system wherein the physical arrangement and volume fraction of the first regions of the susceptor creates a greater surface area for interaction between the applied electromagnetic energy and any secondary electromagnetic energy produced from the interaction of the applied electromagnetic energy with either the first regions, the second regions, the chemical species flow, or any combination thereof, and the chemical species flow to a greater extent in the combined volume of the first regions, the second regions and the chemical species flow when compared to the penetration of the applied electromagnetic energy in the combined volume of either the second regions and the chemical species flow or only the chemical species flow as the chemical species flow passes through the first regions and allows for the synthesis of at least one new biochemical species that is created by catalysis from interaction with the second regions.

Another aspect of this invention is a device for creating a useful energy product from a chemical species flow, the device comprising a macroscopic artificial dielectric structure for a gas-permeable susceptor for subjecting the chemical species flow to applied electromagnetic energy, the structure consisting of first regions that are a solid material and second regions being a catalyst that is a solid material, the first regions and the second regions having different depths of penetration of applied electromagnetic energy, the depth of penetration of the first regions being greater than the depth of penetration of the second regions, wherein: (a) the first regions are discontinuously interspersed at least a certain distance from each other between and among the second regions, (b) the transmission of the applied electromagnetic energy by the first regions provides a means for increase interaction between the applied electromagnetic energy and the chemical species flow, (c) the transmission of the applied electromagnetic energy by the first regions provides a means for increased interaction between the applied electromagnetic energy and catalyst the second regions in the gas-permeable susceptor to interact with the second regions, and (d) the distance between each of the first regions and a volume fraction of the structure that the first regions make up assists the applied electromagnetic energy to penetrate the structure and to interact volumetrically with the susceptor and the chemical species flow passing through the susceptor and allows for the synthesis of at least one new biochemical species that is created by catalysis from interaction with the second regions.

Another aspect of this invention is using a macroscopic artificial dielectric consisting of a catalyst activated by applied electromagnetic energy for a method of making a C.sub.4+ compound comprising with: providing water and a water soluble oxygenated hydrocarbon comprising a C.sub.1+O.sub.1+ hydrocarbon in an aqueous liquid phase and/or a vapor phase, providing H.sub.2, catalytically reacting in the liquid and/or vapor phase the oxygenated hydrocarbon with the H.sub.2 in the presence of a deoxygenation catalyst at a deoxygenation temperature and deoxygenation pressure to produce an oxygenate comprising a C.sub.1+O.sub.1-3 hydrocarbon in a reaction stream, and catalytically reacting in the liquid and/or vapor phase the oxygenate in the presence of a base catalyst at a condensation temperature and condensation pressure.

Another aspect of this invention is using a macroscopic artificial dielectric consisting of a catalyst activated by applied electromagnetic energy for a method of deconstructing biomass. The method generally includes reacting a biomass slurry with a biomass processing solvent comprising a C.sub.2+O.sub.1-3 hydrocarbon at a deconstruction temperature between about 60.degree. C. and 350.degree. C. and a deconstruction pressure between about 50 psi and 2000 psi to produce a biomass hydrolysate comprising at least one member selected from the group consisting of a water-soluble lignocellulose derivative, water-soluble cellulose derivative, water-soluble hemicellulose derivative, carbohydrate, starch, monosaccharide, disaccharide, polysaccharide, sugar, sugar alcohol, alditol, and polyol, wherein the biomass processing solvent is produced by catalytically reacting in the liquid or vapor phase an aqueous feedstock solution comprising water and a water-soluble oxygenated hydrocarbons comprising a C.sub.2+O.sub.1+ hydrocarbon with H.sub.2 in the presence of a deoxygenation catalyst at a deoxygenation temperature and deoxygenation pressure.

Another aspect of this invention is a composition of the biomass processing solvent. In one embodiment, the biomass processing solvent includes a member selected from the group consisting of an alcohol, ketone, aldehyde, cyclic ether, ester diol, triol, hydroxy carboxylic acid, carboxylic acid, and a mixture thereof.

Another aspect of this invention is that the invention is directed to a method of producing hydrogen via the reforming of an oxygenated hydrocarbon feedstock. The method comprises reacting water and a water-soluble oxygenated hydrocarbon having at least two carbon atoms, in the presence of a metal-containing catalyst. The catalyst comprises a metal selected from the group consisting of Group VIII transitional metals, alloys thereof, and mixtures thereof.

Another aspect of this invention is that a catalyst comprise a metal selected from the group consisting of nickel, palladium, platinum, ruthenium, rhodium, iridium, alloys thereof, and mixtures thereof. Optionally, the catalyst may also be further alloyed or mixed with a metal selected from the group consisting of Group IB metals, Group IIB metals, and Group Vllb metals, and from among these, preferably copper, zinc, and/or rhenium. It is also much preferred that the catalyst be adhered to a support, such as silica, alumina, zirconia, titania, ceria, carbon, silica-alumina, silica nitride, and boron nitride. Furthermore, the active metals may be adhered to a nanoporous support, such as zeolites, nanoporous carbon, nanotubes, and fullerenes.

Another aspect of this invention is using a macroscopic artificial dielectric consisting of a catalyst activated by applied electromagnetic energy for a process for producing a fuel comprising: a) treating a first renewable feedstock comprising at least glycerides and a second renewable feedstock comprising at least whole pyrolysis oil concurrently in a first reaction zone by catalytically hydrogenating and catalytically deoxygenating the glycerides and components of the whole pyrolysis oil using at least one catalyst at reaction conditions in the presence of hydrogen to provide an effluent stream comprising hydrogen, water, carbon oxides, and hydrocarbons; and b) separating at least hydrogen, carbon dioxide, and water, from the effluent stream and collecting at least a portion of the remainder for use as a fuel or fuel blending component.

Another aspect of this invention is using a macroscopic artificial dielectric consisting of a catalyst activated by applied electromagnetic energy for a method for deoxygenating a biomass-derived pyrolysis oil, the method comprising the steps of: combining a biomass-derived pyrolysis oil stream with a heated low-oxygen-pyoil diluent recycle stream to form a heated diluted pyoil feed stream that has a feed temperature of about 150.degree. C. or greater; and contacting the heated diluted pyoil feed stream with a first deoxygenating catalyst in the presence of hydrogen at first hydroprocessing conditions effective to form a low-oxygen biomass-derived pyrolysis oil effluent.

Another aspect of this invention is using a macroscopic artificial dielectric consisting of a catalyst activated by applied electromagnetic energy for a method for producing a bio-oil distillated fraction comprising: a) converting biomass in a conversion reactor to thereby produce a conversion reactor effluent comprising vapor conversion products, wherein said conversion reactor contains a catalyst and is operated at a temperature in the range of from about 200.degree. C. to about 1000.degree. C.; b) condensing at least a portion of said vapor conversion products to form a condensate comprising bio-oil and water; c) separating said condensate by gravity separation into a bio-oil stream comprising said bio-oil and less than about 10 wt % water, and into an aqueous phase comprising water and less than about 25 wt % hydrocarbonaceous compounds; d) fractionating a feed comprising said bio-oil stream by molecular distillation to form a bio-oil distillated fraction comprising water and a light bio-naphtha, wherein the feed is not subjected to a vacuum distillation step; and e) separating said bio-oil distillated fraction to form an aqueous distillate fraction comprising said water and to form said light bio-naphtha having a density less than about 0.9, a TAN less than about 4, and comprising less than 1 wt % water.

Another aspect of this invention is using a macroscopic artificial dielectric consisting of a catalyst activated by applied electromagnetic energy for a method comprising: a) providing a first mixture comprising reaction products produced from catalytic conversion of biomass at temperatures ranging from 300.degree. C. to 1000.degree. C., wherein the reaction products include a first oil phase comprising biomass-derived, carbon-containing compounds and a first aqueous phase comprising water, wherein the ratio of the specific gravities of the first oil phase to the first aqueous phase (SGR.sup.1) is greater than 1.0; b) modifying the specific gravity of at least one of said first oil phase and said first aqueous phase, thereby resulting in a second mixture having a second oil phase and a second aqueous phase, wherein the ratio of the specific gravities of said second oil phase to said second aqueous phase (SGR.sup.2) is less than 1.0; and c) separating at least a portion of said second oil phase from said second mixture.

Another aspect of this invention is using a macroscopic artificial dielectric consisting of a catalyst activated by applied electromagnetic energy for a process for producing a renewable biofuel from a catalytically pyrolyzed biomass containing bio-oil stream and a treated bio-oil feed, the process comprising: (a) mixing in a mixing zone at least a portion of the treated bio-oil feed with the pyrolyzed biomass containing bio-oil stream to form a bio-oil mixture; (b) separating water and at least a portion of the heavy fraction from the bio-oil mixture produced in the mixing zone to render a non-heavy fraction of the bio-oil mixture; (c) subjecting the non-heavy fraction of the bio-oil mixture produced in the mixing zone to catalytic deoxygenation in a hydrotreater to form a separated hydrotreated product and, optionally, a partial deoxygenated intermediate and removing the separated hydrotreated product and the optional partial deoxygenated intermediate from the hydrotreater; (d) removing produced water from the separated hydrotreated product; (e) subjecting the separated hydrotreated product of step (c) to fractionation to render oil having a boiling point in excess of 650.degree. F. and at least one hydrocarbon fraction having a boiling point less than 650.degree. F. and; (f) generating renewable biofuel from the separated fractions wherein the treated bio-oil feed is at least one of the following: (i) at least a portion of the separated hydrotreated product; or (ii) at least a portion of the at least one hydrocarbon fraction having a boiling point less than 650.degree. F.; or (iii) a partial deoxygenated intermediate.

Another aspect of this invention is using a macroscopic artificial dielectric consisting of a catalyst activated by applied electromagnetic energy for a process for producing a renewable biofuel from a liquid bio-oil or liquid pyrolysis oil, the process comprising: (a) introducing effluent from a biomass conversion unit into a separator and separating from the effluent a liquid bio-oil or pyrolysis oil; (b) subjecting carbonyl containing oxygenates within the separated liquid bio-oil or pyrolysis oil to a carbon-carbon bond forming condensation reaction in a condensation reactor where distillation occurs in the presence of a heterogeneous acid catalyst to form C.sub.6+enriched condensates, wherein the carbonyl containing oxygenates are selected from the group consisting of C.sub.3 oxygenates, C.sub.4 oxygenates and C.sub.5 oxygenates and mixtures thereof and further wherein the C.sub.3, C.sub.4 and C.sub.5 oxygenates are selected from the group consisting of carboxylic acids, carboxylic acid esters, ketones and aldehydes; (c) contacting the bio-oil or pyrolysis oil containing condensates of step (b) with hydrogen and catalyst, and then hydrotreating the C.sub.6+condensates to form a hydrotreated bio-oil or pyrolysis oil comprising C.sub.6+ enriched hydrocarbons; and (d) removing the hydrotreated bio-oil or pyrolysis oil comprising C.sub.6+ enriched hydrocarbons from the hydrotreater and fractionating the hydrotreated bio-oil or pyrolysis oil comprising C.sub.6+ enriched hydrocarbons to obtain a C.sub.6+ renewable biofuel.

Another aspect of this invention is using a macroscopic artificial dielectric consisting of a catalyst activated by applied electromagnetic energy for a process for producing a fungible bio-oil, said process comprising: (a) subjecting a lignocellulosic material to a thermo-catalytic conversion process to thereby produce a bio-oil; and (b) combining said bio-oil having an organic oxygen content of not more than 15 weight percent with a petroleum-derived composition to produce said fungible bio-oil, wherein the weight ratio of said bio-oil to said petroleum-derived composition in said fungible bio-oil is at least 1:1 and not more than 20:1, wherein said bio-oil has not been subjected to hydrotreatment prior to said combining.

Another aspect of this invention is using a macroscopic artificial dielectric consisting of a catalyst activated by applied electromagnetic energy for a process for producing a renewable biofuel from liquid bio-oil, the process comprising: (a) subjecting a liquid bio-oil feedstream containing carbonyl oxygenates to a carbon-carbon bond forming condensation reaction in the presence of a heterogeneous acid or basic catalyst to form C.sub.6+ enriched condensates, wherein the oxygenates are selected from the group consisting of C.sub.3 oxygenates, C.sub.4 oxygenates, C.sub.5 oxygenates and mixtures thereof, and further wherein the C.sub.3, C.sub.4 and C.sub.5 oxygenates are selected from the group consisting of carboxylic acids, carboxylic acid esters, ketones and aldehydes; (b) contacting the bio-oil containing condensates of step (a) with hydrogen and hydrotreating the condensates to form a hydrotreated bio-oil comprising C.sub.6+ hydrocarbons; and (c) fractionating the hydrotreated bio-oil to obtain a C.sub.6+ renewable biofuel, wherein the condensation reaction in step (a) and the hydrotreating in step (b) occurs in the same reactor.

Another aspect of this invention is using a macroscopic artificial dielectric consisting of a catalyst from the group of catalyst consisting of organic sulfonic acids, perfluoroalkylsulfonic acids, zeolites, sulfated transition metal oxides, and perfluorinated ion exchange polymers containing pendant sulfonic acid, carboxylic acid, or sulfonic acid groups; sulfonated copolymers of styrene and divinylbenzene; sulfated silicas, aluminas, titania and/or zirconia; amorphous SiAl; ZSM-type zeolites, zeolite beta, sulfonated fluoropolymers or copolymers, sulfated zirconia MgO, CaO, SrO, BaO, ZrO.sub.2, TiO.sub.2, CeO and mixtures thereof.

Another aspect of this invention is using a macroscopic artificial dielectric consisting of a catalyst activated by applied electromagnetic energy for a process comprising: (i) mixing a first particulate stream comprising a solid particulate biomass material with a lifting medium in a first mixing zone of a reactor, and fluidizing and transporting said first particulate stream in said lifting medium thereby forming a fluidized first particulate stream; (ii) passing said fluidized first particulate stream to a second mixing zone of said reactor; and (iii) injecting a second particulate stream comprising a heat carrier material that contains a catalyst into said second mixing zone for mixing with said fluidized first particulate stream, resulting in fluidized cracking of at least a portion of said solid particulate biomass material, wherein said second particulate stream is fed to said second mixing zone at an angle which is counter-current to the flow of said fluidized first particulate stream.

Another aspect of this invention is using a macroscopic artificial dielectric consisting of a catalyst activated by applied electromagnetic energy to make a bio-gasoline composition. A biogasoline composition can comprise hydrocarbons and oxygenates and having a total oxygen content of less than 15 weight percent and comprise phenolic compounds in an amount of at least 10 percent by weight. Furthermore, the biogasoline composition can comprise bio-gasoline composition derived from biomass and comprising hydrocarbon compounds and oxygen-and-carbon-containing compounds, wherein the cumulative amount of aliphatic and aromatic hydrocarbons in said bio-gasoline composition is at least 5 weight percent, wherein the amount of said oxygen-and-carbon-containing compounds in said bio-gasoline is at least 15 weight percent, wherein said oxygen-and-carbon-containing compounds are selected from the group consisting of phenolics, furans, ketones, aldehydes, and mixtures thereof, wherein said bio-gasoline composition has a total oxygen content of less than 15 weight percent, wherein said bio-gasoline composition comprises phenolics in an amount of at least 10 weight percent.

Another aspect of this invention is using a macroscopic artificial dielectric consisting of a catalyst activated by applied electromagnetic energy for a A process for the conversion of particulate biomass to a fuel, the process comprising: (a) treating a ZSM-5 zeolite component with a phosphorous-containing compound forming a phosphorous-promoted ZSM-5 component; (b) preparing a slurry comprising the phosphorous-promoted ZSM-5 component and a silica-containing binder, wherein the silica-containing binder comprises silicic acid, polysilicic acid, or a combination of silicic acid and polysilicic acid; (c) shaping the slurry into shaped bodies; and (d) contacting the shaped bodies with a particulate biomass in a reactor under conditions suitable for biomass conversion to a fuel.

Another aspect of this invention is using a macroscopic artificial dielectric consisting of a catalyst activated by applied electromagnetic energy for a process, comprising: i) charging a feed to a first reactor for contact with a heat carrier material that has catalytic properties and conversion of the feed to a product comprising oxygenated hydrocarbons, wherein the feed comprises at least one of (a) a biomass, and (b) a biomass and a synthetic polymer; ii) charging at least a portion of said product to a second reactor along with a synthetic thermoplastic polymer based material for contact with a second reactor catalyst and conversion of said synthetic thermoplastic polymer based material to liquid hydrocarbons; and iii) removing a second reactor bio-oil from said second reactor.

Another aspect of this invention is using a macroscopic artificial dielectric consisting of a catalyst activated by applied electromagnetic energy for a process for producing bio-oil, said process comprising the steps of: a) supplying a particulate biomass material to one or more gas mixing zones; b) supplying one or more carrier gas streams to said gas mixing zones; and c) transporting said biomass material from said gas mixing zones into a reaction zone contain a catalytic material via first and second feed lines, wherein said first and second feed lines supply said biomass to a common reactor within said reaction zone via respective first and second spaced reactor inlets, and wherein said first and second reactor inlets are vertically and/or circumferentially spaced from one another on said common reactor such that said inlets are in fluid communication via said common reactor, wherein said carrier gas streams are used to propel said biomass material during at least a portion of said transporting of step (c).

Another aspect of this invention is using a macroscopic artificial dielectric consisting of a catalyst activated by applied electromagnetic energy for a two-stage process for the conversion of solid particulate biomass material, comprising (i) a first stage in which at least part of the solid particulate biomass material is subjected to thermal pyrolysis in a first zone of a reactor to produce primary reaction products; and (ii) a second stage in which at least part of the primary reaction products is catalytically converted to secondary reaction products in a second zone of the reactor, wherein the first and second zone of said reactor are in fluid communication and wherein the internal diameter of the first zone is greater than the internal diameter of the second zone, wherein the conversion of solid particulate biomass material is carried out in an oxygen-free atmosphere.

Another aspect of this invention is using a macroscopic artificial dielectric consisting of a catalyst activated by applied electromagnetic energy for a process for converting biomass to bio-oil, the process comprising: (a) mixing biomass and at least one inorganic material having catalytic properties, wherein the at least one inorganic material includes a kaolin, a zeolite, or a mixture thereof; and (b) converting at least a portion of the biomass to liquid organic compounds. The following materials can be used as a catalyst: zeolite X, zeolite REY, zeolite RE-USY, zeolite Y, zeolite USY, dealuminated USY zeolite, zeolite ZSM-5, beta zeolite, a silicalite, and a mixture of any two or more of the foregoing.

Another aspect of this invention is using a macroscopic artificial dielectric consisting of a catalyst activated by applied electromagnetic energy for a system for producing a bio-oil, said system comprising: a biomass feedstock source for providing solid particulate biomass; a conversion reactor for catalytically converting said solid particulate biomass into a bio-oil; a separator for separating said bio-oil into at least a bio-gasoline fraction and a bio-distillate fraction; a hydrotreater for catalytic hydrotreating said bio-distillate fraction to thereby produce a hydrotreated product; a fractionator for fractionating said hydrotreated product into at least a hydrotreated bio-gasoline and a hydrotreated bio-diesel; a petroleum-derived gasoline source for providing a petroleum-derived gasoline, a gasoline blending system for combining at least a portion of said bio-gasoline fraction and at least a portion of said hydrotreated bio-gasoline with said petroleum-derived gasoline, wherein said separator is in fluid communication with said gasoline blending system and said separator is configured to introduce at least a portion of said bio-gasoline fraction into gasoline blending system; a petroleum-derived diesel source for providing a petroleum-derived diesel; and a diesel blending system for combining at least a portion of said hydrotreated bio-diesel with said petroleum-derived diesel.

Another aspect of this invention is using a macroscopic artificial dielectric consisting of a catalyst activated by applied electromagnetic energy for a process for preparing a solid biomass material for a biocatalytic cracking process, said process for preparing comprising the steps of (i) providing a particulate, solid biomass material; (ii) forming a composite of said biomass material and a catalytic material; (iii) subjecting said biomass material to a thermal treatment at a torrefaction temperature at or above 200.degree. C., and low enough to avoid significant conversion of said biomass material to liquid conversion products, wherein said thermal treatment is carried out in a reducing gas atmosphere; and (iv) reducing the particle size of said biomass material from step (iii) to thereby form fluidizable particles.

Another aspect of this invention is using a macroscopic artificial dielectric consisting of a catalyst activated by applied electromagnetic energy for a process for catalytic thermolysis of cellulosic biomass, the process comprising heating the cellulosic biomass to a conversion temperature in presence of a catalyst system, wherein the catalyst system comprises a mixed metal oxide represented by the formula (X.sub.1O).(X.sub.2O).sub.a.(X.sub.3Y .sub.b O.sub.4) wherein X.sub.1, X.sub.2 and X.sub.3 are alkaline earth elements selected from the group consisting of Mg, Ca, Be, Ba , and mixture thereof, and Y is a metal selected from the group consisting of Al, Mn, Fe, Co, Ni, Cr, Ga, B, La, P, Ti, Zn and mixture thereof, wherein a is 0 or 1 and b is 0 1 or 2.

Another aspect of this invention is using a macroscopic artificial dielectric consisting of a catalyst activated by applied electromagnetic energy for a process for converting biomass to reaction products, the process comprising: (a) contacting biomass particles with an inorganic material having catalytic properties and mixing the biomass particles and the inorganic material in a liquid suspension medium, the inorganic material including: 1) a zeolite, and 2) at least one of a sepiolite or saponite; and (b) converting the biomass particles to reaction products in the presence of the inorganic material, wherein said biomass particles comprises cellulose or lignocellulose and wherein said converting the biomass particles to reaction products occurs via at least one process chosen from gasification, steam reforming, thermal cracking, coking, catalytic cracking, hydro-cracking, and hydro-processing.

Another aspect of this invention is using a macroscopic artificial dielectric consisting of a catalyst activated by applied electromagnetic energy for a process for producing fuel from biomass comprising: (i) torrefying biomass material at a temperature between 80.degree. C. and 300.degree. C., to form particulated biomass having a mean average particle size from about 1 .mu.M to about 1000 .mu.m; (ii) mixing the particulated biomass, a heat carrier, and a catalyst with an organic liquid solvent to form a suspension, wherein the particulated biomass is present in the suspension in an amount between about 1 weight percent to about 40 weight percent, based on the total weight of the suspension; (iii) feeding the suspension into a hydropyrolysis reactor; (iv) feeding hydrogen and a catalyst into the hydropyrolysis reactor; and (v) converting at least a portion of the particulate biomass of the suspension into bio-oil at a temperature of at least 300.degree. C., and a pressure between 1 atm to 200 atm.

Another aspect of this invention is using a macroscopic artificial dielectric consisting of a catalyst activated by applied electromagnetic energy for a process for converting a biomass material to a stabilized bio-oil, said process comprising the steps of (i) converting at least part of the biomass material to a pyrolytic oil having suspended therein particles of metal compounds; and (ii) removing at least part of the suspended metal compounds from the pyrolytic oil to obtain a bio-oil having a reduced metal content, wherein step (i) comprises heating said biomass material and/or biomass pyrolytic vapors produced from said biomass material in the presence of a catalyst.

Another aspect of this invention is using a macroscopic artificial dielectric consisting of a catalyst activated by applied electromagnetic energy for a process for producing a renewable fuel, said process comprising: (a) utilizing a bio-oil having an oxygen content in the range of 15 to 50 weight percent; (b) separating said bio-oil into at least a light fraction and a heavy fraction, wherein the mid-boiling point of said heavy fraction is at least 100.degree. C. greater than the mid-boiling point of said light fraction; (c) hydrotreating with a catalyst Another aspect of this invention is using a macroscopic artificial dielectric consisting of a catalyst activated by applied electromagnetic energy for a Another aspect of this invention is using a macroscopic artificial dielectric consisting of a catalyst activated by applied electromagnetic energy for a at least a portion of said light fraction to thereby provide a hydrotreated light fraction; and (d) blending said hydrotreated light fraction with a petroleum-derived distillate or a petroleum-derived gasoline.

Another aspect of this invention is using a macroscopic artificial dielectric consisting of a catalyst activated by applied electromagnetic energy for a process for producing a renewable fuel, said process comprising: (a) utilizing a bio-oil having an oxygen content in the range of 15 to 50 weight percent; (b) separating said bio-oil into at least a light fraction and a heavy fraction, wherein the mid-boiling point of said heavy fraction is at least 100.degree. C. greater than the mid-boiling point of said light fraction; and (c) hydrotreating with a catalyst at least a portion of said light fraction to thereby provide a hydrotreated light fraction, wherein said separating of step (b) includes further separating said bio-oil into an intermediate fraction having a mid-boiling point between the mid-boiling points of said light fraction and said heavy fraction, wherein said process further comprises hydrotreating with a catalyst at least a portion of said intermediate fraction to produce a hydrotreated intermediate fraction.

Another aspect of this invention is using a macroscopic artificial dielectric consisting of a catalyst activated by applied electromagnetic energy for a process for converting particulate solid biomass material to a bio-oil, said process comprising the steps of (i) forming a composition of matter comprising an intimate mixture of the solid particulate biomass material and a carbonaceous material; and (ii) subjecting the composition of matter of step (i) to a pyrolysis reaction in the presence of a catalyst.

Another aspect of this invention is using a macroscopic artificial dielectric consisting of a catalyst activated by

What is claimed:

1. A process for creating at least one biochemical species that is a biochemical product from at least one biochemical species that is a biochemical reactant originating from biomass where the biochemical reactant is part of a chemical species flow comprising passing the chemical species flow through a macroscopic artificial dielectric susceptor structure that is a gas-permeable susceptor, and subjecting the structure to at least one wavelength of applied electromagnetic energy, the structure consisting of at least two regions where first regions and second regions are solid materials, the second regions contain a solid catalytic material, the first regions and the second regions having different dielectric properties to at least one wavelength of the applied electromagnetic energy, the dielectric properties of the first regions being greater than the depth of penetration of the second regions, wherein: (a) the first regions are discontinuously interspersed at least a certain distance from each other between and among the second regions, (b) the transmission of the applied electromagnetic energy by the first regions provides a means for increase interaction between the applied electromagnetic energy and the chemical species flow (c) the transmission of the applied electromagnetic energy by the first regions provides a means for increased interaction between the applied electromagnetic energy and the second regions in the gas-permeable susceptor to interact with the catalyst of the second regions, and (d) the distance between each of the first regions and a volume fraction of the structure that the first regions make up assists the applied electromagnetic energy to penetrate the structure and to interact volumetrically with the susceptor and the chemical species flow passing through the susceptor and allows for the synthesis of at least one biochemical product species that is created by catalysis from interaction with the second regions.

2. The macroscopic artificial dielectric system in claim 1, wherein the macroscopic artificial dielectric in claim 1 further comprises of 3^{rd} regions that are solid materials.

3. The 3^{rd} regions in claim 2, wherein the 3^{rd} regions are made of a solid material that are heat carriers.

4. The solid material as in claim 3 wherein the solid material is selected from the group of materials selected from a metal, a ceramic, a carbide, nitride, boride, a metal alloy, an oxide, an artificial dielectric susceptor, a materials with Curie point, a sulfide, a sulfate, fluoropolymer composite, polypropylene composite, a silicone composite, a material that can radiate at least one wavelength of infra-red wavelengths when said material has first absorbed at least one wavelength of applied electromagnetic energy, a material that can radiate at least wavelength of infra-red wavelengths when said material has first absorbed at least one wavelength of applied electromagnetic energy, a clay material, a material with a talc structure, an inorganic material with a pseudomorphic structure, an material containing a field concentrator, an electromagnetic susceptor with a coating, an electromagnetic susceptor of sintered ceramic materials, a materials that has attrition properties as an abrasive, or a combination thereof.

5. The 3^{rd} regions as in claim 2, wherein the 3^{rd} regions contain a solid material that is a solid biomass that is a solid biochemical reactant where the solid biomass is selected group of solid biomass consisting of a lignin material, a lignocellulose material, a sugar, cellulose, hemicellulose, a char product or a combination thereof.

6. The 3^{rd} regions as in claim 3, wherein the 3^{rd} regions consist of a solid catalytic material.

7. The solid catalytic material in the 3^{rd} regions as in claim 6 wherein the solid catalytic materials contains a support material.

8. The solid catalytic material in the 2^{nd} Regions as in claim 1 wherein the solid catalytic material contains a support material.

9. The catalyst as in the 3^{rd} regions as in claim 6 wherein the catalyst used in the 3^{rd} regions is a different catalyst for a different function compared to the function of the catalyst used in the 2^{nd} regions.

10. The catalyst as in the 3^{rd} regions as claim 6 wherein the catalyst in the 3^{rd} regions has the same function as the catalyst in the 2^{nd} regions but the catalyst in 3^{rd} regions is a different catalytic material as compared to the catalytic material of the catalyst in the 2^{nd} Region.

11. The solid catalyst in 2^{nd} regions as in claim 1, wherein is the function of said catalyst is selected from the group of functions consisting of dewatering, cracking, demetallization, desulfurization, dehydration, isomerization, oxidation of alcohols, deoxygenation, decarboxylation, regenerating coke, isomerization, hydrotreating, dehydroxylation, Fisher-Tropsch synthesis of syngas, methanization, reforming, pyrolysis, aqueous phase reforming, separation of chemical species, reactive distillation, hydro-dewatering, hydrocracking, hydrodemetallization, hydrodesulfurization, dehydration, hydroisomerization, hydrooxidation of alcohols, hydrodeoxygenation, hydrodecarboxylation, hydroregenerating coke, hydrotreating, hydrodehydroxylation, Fisher-Tropsch synthesis of syngas, hydromethanization, hydroreforming, hydropyrolysis, aqueous phase hydroreforming, separation of chemical species, reactive hydrodistillation, liquid phase separation, a Diels-Alder reaction, a aldol condensation reaction, Michael addition reaction, a Robinson annulation reaction and evaporation.

12. The solid catalyst in the 3^{rd} regions as in claim 6, wherein is the function of said catalyst is selected from the group of functions consisting of dewatering, cracking, demetallization, desulfurization, dehydration, isomerization, oxidation of alcohols, deoxygenation, decarboxylation, regenerating coke, isomerization, hydrotreating, dehydroxylation, Fisher-Tropsch synthesis of syngas, methanization, reforming, pyrolysis, aqueous phase reforming, separation of chemical species, reactive distillation, hydro-dewatering, hydrocracking, hydrodemetallization, hydrodesulfurization, dehydration, hydroisomerization, hydrooxidation of alcohols, hydrodeoxygenation, hydrodecarboxylation, hydroregenerating coke, hydrotreating, hydrodehydroxylation, Fisher-Tropsch synthesis of syngas, hydromethanization, hydroreforming, hydropyrolysis, aqueous phase hydroreforming, separation of chemical species, reactive hydrodistillation, liquid phase separation, a Diels-Alder reaction, a aldol condensation reaction, Michael addition reaction, a Robinson annulation reaction and evaporation.

13. The applied electromagnetic energy as in claim 1 wherein the applied electromagnetic energy has a type of radiation that is selected from the group of types of radiation of electromagnetic energy consisting of infrared radiation, radio frequency radiation, ultraviolet radiation, microwave radiation, visible range radiation, a mixed of radiation types from a single source of electromagnetic energy, pulsed, variable frequency, continuous or a combination thereof.

14. The applied electromagnetic energy as in claim 1 wherein two or more wavelengths of applied electromagnetic energy that is selected from the same type of radiation.

15. The applied electromagnetic energy as in claim 1 wherein two or more wavelengths of electromagnetic energy is selected from different types of radiation.

16. The macroscopic artificial dielectric susceptor system having a function as in claim 1, wherein the function of the macroscopic artificial dielectric susceptor system is selected from the group of functions consisting of dewatering, cracking, demetallization, desulfurization, dehydration, isomerization, oxidation of alcohols, deoxygenation, decarboxylation, regenerating coke, isomerization, hydrotreating, dehydroxylation, Fisher-Tropsch synthesis of syngas, methanization, reforming, pyrolysis, aqueous phase reforming, separation of chemical species, reactive distillation, hydro-dewatering, hydrocracking, hydrodemetallization, hydrodesulfurization, dehydration, hydroisomerization, hydrooxidation of alcohols, hydrodeoxygenation, hydrodecarboxylation, hydroregenerating coke, hydrotreating, hydrodehydroxylation, Fisher-Tropsch synthesis of syngas, hydromethanization, hydroreforming, hydropyrolysis, aqueous phase hydroreforming, separation of chemical species, reactive hydrodistillation, liquid phase separation a Diels-Alder reaction, a aldol condensation reaction, Michael addition reaction, a Robinson annulation reaction, and evaporation.

17. Process as in claim 1, wherein the function of the process for chemical reaction is selected from the group of functions consisting of dewatering, cracking, demetallization, desulfurization, dehydration, isomerization, oxidation of alcohols, deoxygenation, decarboxylation, regenerating coke, isomerization, hydrotreating, dehydroxylation, Fisher-Tropsch synthesis of syngas, methanization, reforming, pyrolysis, aqueous phase reforming, separation of chemical species, reactive distillation, hydro-dewatering, hydrocracking, hydrodemetallization, hydrodesulfurization, dehydration, hydroisomerization, hydrooxidation of alcohols, hydrodeoxygenation, hydrodecarboxylation, hydroregenerating coke, hydrotreating, hydrodehydroxylation, Fisher-Tropsch synthesis of syngas, hydromethanization, hydroreforming, hydropyrolysis, aqueous phase hydroreforming, separation of chemical species, reactive hydrodistillation, liquid phase separation, a Diels-Alder reaction, a aldol condensation reaction, Michael addition reaction, a Robinson annulation reaction and evaporation .

18. The process as in claim 1, wherein the said process is carried in a reactor device selected from the group reactor devices consisting of a fixed bed reactor, a fluidized catalystic cracker, a riser reactor, a slurry reactor, a plug flow reactor, a continuously stirred reactor, a batch reactor, a high pressure reactor, bubble column reactor, a semi-batch reactor, catalytic reactor, fuidized bed reactor, trickle-bed reactor, a triphase reactor, a cyclonic reactor, a catalytic cyclonic reactor, multiphase reactor, a tubular flow reactor, tri phase reactor, slurry column reactor, three phase bubble reactor, slurry phase bubble column reactor, artificial dielectric device and a combination thereof.

19. The applied electromagnetic energy as in claim 1, wherein the applied electromagnetic energy contains two applied wavelengths where first wavelength is chosen from a microwave wavelength that interacts with the catalytic material of the 2^{nd} Regions and the second wavelength is chosen from an infra-red wavelength for primary interaction with the chemical species flow.

20. The applied electromagnetic energy as in claim 1, wherein the applied electromagnetic energy contains two applied wavelengths where first wavelength is chosen from a microwave wavelength that interacts with the catalytic material of the 2^{nd} Regions and the second wavelength is chosen from the radio frequency wavelength for primary interaction with the chemical species flow.

21. The applied electromagnetic energy as in claim 1, wherein the applied electromagnetic energy contains two applied wavelengths where first wavelength is chosen from a microwave frequency that interacts with the catalytic material of the 2^{nd} Regions and the second wavelength is chosen from an radio frequency wavelength for primary interaction with the solid biomass in the 3^{rd} regions.

22. The applied electromagnetic energy as in claim 1, wherein the applied electromagnetic energy contains more than two applied wavelengths where first wavelength is chosen from a microwave wavelength that interacts with the catalytic material of the 2^{nd} Regions and the remaining wavelengths are chosen from an infra-red wavelength for primary interaction with the chemical species flow

23. The solid catalytic material of the 3^{nd} region as in claim 6, wherein solid catalytic materials of the 3^{nd} region is select from the group of solid catalytic materials select from the group of catalyst consisting of a clay, a zeolite, metal, an alumina material, a silica material, a carbonate, a sulfide, a sulfate, a hydroxide, a cation doped material, and anion doped material, a precious metal, Pt, d, Ag, a pseudomorphic materials, an artificial dielectric susceptor, a materials with a coating, a materials with a Curie pt., a metal hydride, an interstitial metal hydride, a carbon species or combination thereof.

24. The chemical species flow as in claim 1 wherein the chemical species flow contains liquid that has polar molecules that absorb at least one wavelength of the applied electromagnetic energy

25. The chemical species flow as in claim 1 wherein the chemical species flow contains a liquid that has non-polar molecules that has very low absorption of at least on wavelength of the applied electromagnetic energy.

26. The chemical species flow as in claim 1 wherein the chemical species flow contains a gas that has polar molecules that absorb at least one wavelength of the applied electromagnetic energy

27. The solid catalytic material of the 2^{nd} region as in claim 1, wherein solid catalytic materials of the 2^{nd} region is select from the group of solid catalytic materials consisting of a clay, a zeolite, metal, an alumina material, a silica material, a carbonate, a sulfide, a sulfate, a hydroxide, a cation doped material, and anion doped material, a precious metal, Pt, d, Ag, a pseudomorphic materials, a metal hydride, an interstitial metal hydride, a material that has a support, a material with a Curie Pt., a materials that has a coating, and artificial dielectric susceptor, a carbon species or combination thereof.

28. The biomass as in claim 1 wherein the biomass is derived from all of or a part of a variety of hemp (cannabis) where all of or part of a variety of hemp (cannabis) is selected from the group consist of a at least one liquid biochemical species, a char consisting of at least one biochemical species, at least one gaseous material, at least one solid species from hemp (cannabis) lignocellulose, a solid species from hemp (cannabis) hemicellulose, a solid species from hemp (cannabis) cellulose, a bast fiber of hemp (cannabis), a non-bast fiber of hemp (cannabis) , sugar from hemp (cannabis) or a combination thereof.

29. The process as claimed in claim 1, wherein the distance between each of the first regions and a volume fraction of the structure that the first regions make up assists the applied electromagnetic energy to penetrate the structure and to interact volumetrically with the susceptor and the chemical species flow to a greater extent in the combined volume of the first regions, the second regions and the chemical species flow when compared to the penetration of the applied electromagnetic energy in the combined volume of either the second regions and the chemical species flow or only the chemical species flow as the chemical species flow passes through the first regions and allows for the synthesis of at least one new biochemical species that is created by catalysis from interaction with the second regions.

30. The process as claimed in claim 1, wherein the physical arrangement and volume fraction of the first regions of the susceptor creates a greater surface area for interaction between the applied electromagnetic energy and any secondary electromagnetic energy produced from the interaction of the applied electromagnetic energy with either the first regions, the second regions, the chemical species flow, the useful energy product or any combination thereof, and the chemical species flow to a greater extent in the combined volume of the first regions, the second regions and the chemical species flow when compared to the penetration of the applied electromagnetic energy in the combined volume of either the second regions and the chemical species flow or only the chemical species flow as the chemical species flow passes through the first regions and allows for the synthesis of at least one new biochemical species that is created by catalysis from interaction with the second regions.

31. A system for creating at least one biochemical species that is a biochemical product from at least one biochemical species that is a biochemical reactant originating from biomass where the biochemical reactant is part of a chemical species flow, the system comprising: a macroscopic artificial dielectric structure for a gas-permeable susceptor, the structure consisting of first regions being a solid material and second regions being a catalyst that is a solid materials, the first regions and the second regions having different depths of penetration of applied electromagnetic energy, the depth of penetration of the first regions being greater than the depth of penetration of the second regions that are a solid with catalytic properties, and flowing the chemical species flow through the gas-permeable susceptor, and subjecting the chemical species flow and catalyst of the second regions to the applied electromagnetic energy within the structure, wherein: (a) the first regions are discontinuously interspersed at least a certain distance from each other between and among the second regions, (b) the transmission of the applied electromagnetic energy by the first regions provides a means for increase interaction between the applied electromagnetic energy and the chemical species flow (c) the transmission of the applied electromagnetic energy by the first regions provides a means for increased interaction between the applied electromagnetic energy and the catalyst of second regions in the gas-permeable susceptor to interact with the catalyst in the second regions, and (d) the distance between each of the first regions and a volume fraction of the structure that the first regions make up assists the applied electromagnetic energy to penetrate the structure and to interact volumetrically with the susceptor and the chemical species flow passing through the susceptor and allows for the synthesis of at least one biochemical product species that is created by catalysis from interaction with the second regions.

32. The macroscopic artificial dielectric structure in claim 31 the further comprises of 3^{rd} regions that are a solid material.

33. The solid material in the 3^{rd} region in claim 32 where in the solid materials is selected from the group consisting of a solid material that is a heat carrier, a solid material that is a catalyst, a solid material that is a catalyst with a support material, a solid material that is an abrasive material or a combination thereof.

34. A device for creating at least one biochemical species that is a biochemical product from at least one biochemical species that is a biochemical reactant originating from biomass where the biochemical reactant is part of a chemical species flow, the device comprising a macroscopic artificial dielectric structure for a gas-permeable susceptor for subjecting the chemical species flow to applied electromagnetic energy, the structure consisting of first regions being a solid material and second regions being a catalyst that is a solid material that, the first regions and the second regions having different depths of penetration of applied electromagnetic energy, the depth of penetration of the first regions being greater than the depth of penetration of the second regions, wherein: (a) the first regions are discontinuously interspersed at least a certain distance from each other between and among the second regions, (b) the transmission of the applied electromagnetic energy by the first regions provides a means for increase interaction between the applied electromagnetic energy and the chemical species flow, (c) the transmission of the applied electromagnetic energy by the first regions provides a means for increased interaction between the applied electromagnetic energy and the catalyst in the second regions in the gas-permeable susceptor to interact with the second regions, and (d) the distance between each of the first regions and a volume fraction of the structure that the first regions make up assists the applied electromagnetic energy to penetrate the structure and to interact volumetrically with the susceptor and the chemical species flow passing through the susceptor and allows for the synthesis of at least one biochemical product species that is created by catalysis from interaction with the second regions.

35. The macroscopic artificial dielectric structure as in claim 34 that further comprises of 3^{rd} regions that are a solid material.

36. The solid material in the 3^{rd} region as in claim 35 wherein the solid materials is selected from the group consisting of a solid material that is a heat carrier, a solid material that is a catalyst, a solid material that is a catalyst with a support material, a solid material that is an abrasive material or a combination thereof.

37. The 3^{rd} regions as in claim 32, wherein the 3^{rd} regions contain a solid biomass that is a solid biomass that is a solid biochemical reactant where the solid biomass is selected group of solid biomass consisting of a lignin material, a lignocellulose material, a sugar, cellulose, hemicellulose, a char product or a combination thereof.

38. The 3^{rd} regions as in claim 35, wherein the 3^{rd} regions contain a solid material that is a solid biomass that is solid biochemical reactant where the solid biomass is selected group of solid biomass consisting of a lignin material, a lignocellulose material, a sugar, cellulose, hemicellulose, a char product or a combination thereof.

39. The biomass as in claim 31 wherein the biomass is derived from all of or a part of a variety of hemp (cannabis) where all of or part of a variety of hemp (cannabis) is selected from the group consist of a at least one liquid biochemical species, a char consisting of at least one biochemical species, at least one gaseous material, at least one solid species from hemp (cannabis) lignocellulose, a solid species from hemp (cannabis) hemicellulose, a solid species from hemp (cannabis) cellulose, a bast fiber of hemp (cannabis), a non-bast fiber of hemp (cannabis) , sugar from hemp (cannabis) or a combination thereof.

40. The biomass as in claim 34 wherein the biomass is derived from all of or a part of a variety of hemp (cannabis) where all of or part of a variety of hemp (cannabis) is selected from the group consist of a at least one liquid biochemical species, a char consisting of at least one biochemical species, at least one gaseous material, at least one solid species from hemp (cannabis) lignocellulose, a solid species from hemp (cannabis) hemicellulose, a solid species from hemp (cannabis) cellulose, a bast fiber of hemp (cannabis), a non-bast fiber of hemp (cannabis), sugar from hemp (cannabis) or a combination thereof.

41. The solid material as in the 3^{rd} regions as in claim 28 wherein the biomass is derived from all of or a part of a variety of hemp (cannabis) where all of or part of a variety of hemp (cannabis) is selected from the group consist of a char consisting of at least one biochemical species, at least one solid material from hemp (cannabis) lignocellulose, a solid material from hemp (cannabis) hemicellulose, at least one solid materials from hemp (cannabis) cellulose, at least one solid material that is derived from a bast fiber of hemp (cannabis), a solid material that is derived from a non-bast fiber of hemp (cannabis) , a solid material that is a sugar that is derived from hemp (cannabis) or a combination thereof.

42. The solid material as in the 3^{rd} regions as in claim 37 wherein the biomass is derived from all of or a part of a variety of hemp (cannabis) where all of or part of a variety of hemp (cannabis) is selected from the group consist of a char consisting of at least one biochemical species, at least one solid material from hemp (cannabis) lignocellulose, a solid material from hemp (cannabis) hemicellulose, at least one solid materials from hemp (cannabis) cellulose, at least one solid material that is derived from a bast fiber of hemp (cannabis), a solid material that is derived from a non-bast fiber of hemp (cannabis) , a solid material that is a sugar that is derived from hemp (cannabis) or a combination thereof.

43. The solid material as in the 3^{rd} regions as in claim 38 wherein the biomass is derived from all of or a part of a variety of hemp (cannabis) where all of or part of a variety of hemp (cannabis) is selected from the group consist of a char consisting of at least one biochemical species, at least one solid material from hemp (cannabis) lignocellulose, a solid material from hemp (cannabis) hemicellulose, at least one solid materials from hemp (cannabis) cellulose, at least one solid material that is derived from a bast fiber of hemp (cannabis), a solid material that is derived from a non-bast fiber of hemp (cannabis), a solid material that is a sugar that is derived from hemp (cannabis) or a combination thereof.
